(19) United States
(12) Patent Application Publication
(10) Pub. No.: US 2026/0118216 A1
(43) Pub. Date: Apr. 30, 2026

(54) METHOD AND MONITORING DEVICE FOR MONITORING A TORSIONAL RIGIDITY OF A ROTATIONALLY DRIVEN SYSTEM

(71) Applicants: ZF FRIEDRICHSHAFEN AG, Friedrichshafen (DE); ZF Wind Power Antwerpen N.V., Lommel (BE)

(72) Inventors: Sebastian ORTMANN, Lohr (DE); Tobias BECKER, Antwerp (BE)

(21) Appl. No.: 19/366,601

(22) Filed: Oct. 23, 2025

(30) Foreign Application Priority Data
Oct. 28, 2024 (DE) 10 2024 210 359.4

(51) Int. Cl. G01M 13/02

(52) U.S. Cl. CPC G01M 13/02

(57) ABSTRACT

A method for monitoring a torsional rigidity of a rotationally driven system includes determining a first torsional-rigidity-dependent system parameter ensuing in a first region of the system, determining a second torsional-rigidity-dependent system parameter ensuing in a second region of the system, and presupposing that one region out of the two regions has a predetermined torsional rigidity. The first torsional-rigidity-dependent system parameter with the second torsional-rigidity-dependent system parameter. A change to the torsional rigidity of the system is determined in the other region based on a comparison result resulting from the comparing.

### CROSS REFERENCE TO RELATED APPLICATIONS

This application claims benefit to German Patent Application No. DE 10 2024 210 359.4, filed on Oct. 28, 2024, which is hereby incorporated by reference herein.

### FIELD

The present disclosure relates to a method and to a monitoring device for monitoring a torsional rigidity of a rotationally driven system. The present disclosure also relates to an installation comprising a monitoring device of this kind.

### BACKGROUND

The prior art discloses determining the torsional rigidity of a rotating machine component on the basis of a registered angle of twist of the machine component and an established torsional moment or an established variable linked to the torsional moment. To determine the torsional rigidity of a rotating machine component, it is thus known from the prior art to also take account of an established torsional moment in addition to a registered angle of twist. According to methods known from the prior art, therefore, the torsional rigidity is determined depending on the torsional moment.

### SUMMARY

In an embodiment, the present disclosure provides a method for monitoring a torsional rigidity of a rotationally driven system. The method includes determining a first torsional-rigidity-dependent system parameter ensuing in a first region of the system based on a torsional moment acting on the system, determining a second torsional-rigidity-dependent system parameter ensuing in a second region of the system based on the torsional moment, and presupposing that one region out of the first region and the second region has a predetermined torsional rigidity. The first torsional-rigidity-dependent system parameter is compared with the second torsional-rigidity-dependent system parameter. A change to the torsional rigidity of the system is determined in that other region out of the first region and the second region which has not been presupposed as having the predetermined torsional rigidity in the presupposition step, based on a comparison result resulting from the comparing.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view of a rotationally driven system according to one embodiment of the present disclosure;

FIG. 2 is a schematic view of a rotationally driven system according to a further embodiment of the present disclosure;

FIG. 3 is a flowchart comprising steps of a method for monitoring a torsional rigidity of the rotationally driven system from FIG. 1 or 2, according to an embodiment of the present disclosure; and

FIG. 4 is a schematic view of an installation comprising the system from FIG. 1 or 2 and a monitoring device for monitoring the torsional rigidity of the system, according to an embodiment of the present disclosure.

### DETAILED DESCRIPTION

One aspect relates to a method for monitoring a torsional rigidity of a rotationally driven system. The system may be a machine system, for example a drive system for transmitting a torque. The method may thus be carried out to monitor the status of the machine system. The system may have or be a rotationally driven component, in which case the method can be carried out to monitor the torsional rigidity of the rotationally driven component. The component may be a machine component. The torsional rigidity may be a torsional strength or a twisting strength of the system. The torsional rigidity may relate to at least one of either a torsional rigidity of a material of a system component or a torsional rigidity of a connection between two system components. The torsional rigidity of the material may be dependent on material wear or material fatigue. The torsional rigidity of the connection may be dependent on a clearance or a slip between the system components. The rotationally driven system exhibits a torsion, which may be a twisting of the system under the effect of a torsional moment on the system. A torque may be transmitted to or act on the rotationally driven system and lead to torsion of the system. The following steps of the method can be carried out repeatedly.

As one step, the method comprises determining a first torsional-rigidity-dependent system parameter. The first system parameter ensues in a first region of the system on the basis of a torsional moment acting on the system. The first system parameter may ensue in the first region depending on the torsional rigidity in the first region. The torsional rigidity of the first region may be the system torsional rigidity that is to be monitored. The first system parameter may be an angle of twist that ensues in the first region on the basis of the torsional moment. The angle of twist may be based on a material twisting of the first region. As an alternative to the angle of twist, the first system parameter may be a strain that ensues in the first region on the basis of the torsional moment. The strain may be based on a material strain in the first region. As an alternative to the angle of twist, the first system parameter may furthermore be an oscillation parameter, for example a frequency, that may ensue in the first region on the basis of the torsional moment.

As a further step, the method comprises determining a second torsional-rigidity-dependent system parameter. The second system parameter ensues in the second region of the system on the basis of the torsional moment acting on the system. The first system parameter may ensue in the second region depending on the torsional rigidity in the second region. The torsional rigidity of the second region may be the system torsional rigidity that is to be monitored. The second system parameter may be an angle of twist that ensues in the second region on the basis of the torsional moment. The angle of twist may be based on a material twisting of the second region. As an alternative to the angle of twist, the second system parameter may be a strain that ensues in the second region on the basis of the torsional moment. The strain may be based on a material strain in the second region. The first region and the second region may be spaced apart from one another, be adjacent to one another, adjoin one another, or partly overlap. As an alternative to the angle of twist, the second system parameter may furthermore be an oscillation parameter or a frequency that may ensue in the second region on the basis of the torsional moment.

According to corresponding embodiments, the first system parameter and the second system parameter may be parameters of the same kind or of different kinds that may ensue in the first region and the second region depending on the torsional rigidity. The torsional moment that acts on the system and can lead to the generation of the first system parameter and the second system parameter may be a torsional moment that is neither predetermined nor to be determined when the method is carried out. Therefore, in an advantageous and efficient manner, in order to carry out the method it may not be necessary to qualitatively or quantitatively determine the torsional moment in order to monitor the torsional rigidity of the system.

As a further step, the method comprises presupposing that one region out of the first region and the second region has a predetermined torsional rigidity. In the presupposition step, an assumption can be made that said one region out of the first region and the second region has the predetermined torsional rigidity. The predetermined torsional rigidity may be a torsional rigidity that is constant over time in said one region out of the first region and the second region. The predetermined torsional rigidity may be a torsional rigidity, determined or established when the system is produced or put into service and therefore determined before the method is carried out, of said one region out of the first region and the second region. Thus, the method for monitoring the torsional rigidity of the system can be carried out when the system is in operation after having been produced and put into service. Furthermore, the predetermined torsional rigidity may be a functionally predetermined torsional rigidity that is predetermined depending on at least one influencing parameter that acts on the system when the system is in operation. Therefore, the predetermined torsional rigidity may also be predetermined depending on the at least one influencing parameter.

As a further step, the method comprises comparing the first system parameter with the second system parameter. In the comparison step, a ratio or quotient of the first system parameter and the second system parameter can be created. A comparison result resulting from the comparison step may therefore be a ratio or quotient of the first system parameter and the second system parameter. Alternatively or additionally to the ratio or quotient, a difference between the first system parameter and the second system parameter, or a deviation of the second system parameter from the first system parameter, can be generated in the comparison step. Alternatively or additionally to the ratio or quotient, therefore, a comparison result resulting from the comparison step may also be a difference between the first system parameter and the second system parameter or a deviation of the second system parameter from the first system parameter. The comparison step, like all other steps of the method, can be carried out for system parameters of the same kind and system parameters of different kinds.

As a further step, the method comprises determining a change to the torsional rigidity of the system in the other region out of the first region and the second region, it not having been presupposed in the presupposition step that said other region out of the first region and the second region has the predetermined torsional rigidity. The other region may have at least one system component. If the other region has at least two system components, these can be interconnected in order to transmit a torque. The connection may be any suitably known connection. The change in the torsional rigidity may occur in a system component or at the connection. The change may be a relative change of the torsional rigidity of the first region by comparison with the torsional rigidity of the second region, or vice versa. The other region may be the region that is to be monitored for a torsional rigidity that has changed or decreased. The change may be a local change to the torsional rigidity in the other region. The change to the torsional rigidity may be a decrease in the torsional rigidity. Therefore, the method can monitor the system for any failure or rupture that may result from a decreased torsional rigidity in the other region. The step of determining the change to the torsional rigidity is carried out on the basis of a comparison result resulting from the comparison step. Therefore, in the step of determining the change to the torsional rigidity in the other region, the fact that the torsional rigidity of the system has changed can be determined depending on the quotient, ratio, difference, or deviation. In the step of determining the change to the torsional rigidity, it can be determined that the torsional rigidity has changed if the quotient differs from a predetermined quotient, the ratio differs from a predetermined ratio, the difference differs from a predetermined difference, or the deviation differs from a predetermined deviation. Therefore, in the step of determining the change to the torsional rigidity, it can be determined that the torsional rigidity of the system has changed if the quotient, ratio, difference, or deviation varies over time. For this purpose, the steps of the method can be carried out repeatedly, and the first system parameter and the second system parameter can be repeatedly determined and compared with one another.

The determination of the change to the torsional rigidity of the system on the basis of the comparison step is based on the finding that the method allows a change to the torsional rigidity of the system to be determined independently of the torsional moment acting on the system. Moreover, the step of determining the change to the torsional rigidity is thus based on the further finding that, on the basis of the comparison step, the change to the torsional rigidity can also be determined independently of a load acting on the system. Thus, on the basis of the relative comparison of the system parameters which can be carried out in the comparison step and on which the determination of the change to the torsional rigidity can be based, a local change to a system rigidity can be determined independently of a moment acting on the system or a load acting on the system. A system outage based on a system failure caused by a decreased system rigidity can thus be anticipated using the method.

According to one embodiment of the method, in the step of determining the first system parameter, a first torsional-rigidity-dependent measured variable can be sensed at the first region. According to this embodiment, in the step of determining the second system parameter, a second torsional-rigidity-dependent measured variable can be sensed at the second region. Furthermore, in the comparison step, the first measured variable can be compared with the second measured variable. The first measured variable may comprise at least an angle of twist sensed at the first region and a strain sensed at the first region. The second measured variable may comprise at least an angle of twist sensed at the second region and a strain sensed at the second region. A comparison result resulting from the comparison step may be a ratio between the measured variables, a quotient of the measured variables, a difference between the measured variables, or a deviation of one measured variable of the measured variables from the other measured variable of the measured variables. The first measured variable may be registered by a sensor arranged at the first region. The second measured variable may be registered by a sensor arranged at the second region. The sensor may be an angle sensor, for example an inductive sensor, a speed sensor, or an acceleration sensor for registering the angle of twist. Furthermore, the sensor may be a strain sensor, for example a strain gauge or an optical waveguide, for registering the strain. The first system parameter may comprise or be based on the first measured variable. The second system parameter may comprise or be based on the second measured variable. Thus, the torsional-rigidity-dependent system parameters can be determined relative to one another in an efficient manner.

According to a further embodiment of the method, in the steps of determining the first system parameter and the second system parameter, the first system parameter and the second system parameter may be system parameters of the same kind. In the comparison step, therefore, system parameters of the same kind can be compared with one another. Furthermore, in the steps of determining the first system parameter and the second system parameter, the first measured variable and the second measured variable may be measured variables of the same kind. In the comparison step, therefore, measured variables of the same kind can also be compared with one another. In this way, for example, a change to the torsional rigidity of the system can be determined on the basis of a ratio of an angle of twist sensed at the first region and an angle of twist sensed at the second region. Presupposing that one region out of the first region and the second region has the predetermined torsional rigidity, it can thus be determined that when a ratio of the angles of twist deviates from a predetermined ratio of the angles of twist, the torsional rigidity of the system has changed in that other region out of the first region and the second region which has not been presupposed as having the predetermined torsional rigidity in the presupposition step. Taking the predetermined torsional rigidity as given, it is thus possible, on the basis of the angle of twist, to reliably monitor whether and in which region the torsional rigidity in the system has changed.

According to a further embodiment of the method, in the step of determining the first system parameter, a first angle of twist ensuing in the first region on the basis of the torsional moment can be determined. According to this embodiment, in the step of determining the second system parameter, a second angle of twist ensuing in the second region on the basis of the torsional moment can be determined. Furthermore, in the comparison step, the first angle of twist can be compared with the second angle of twist. The comparison result resulting from the comparison step may thus be a ratio of the angles of twist, a quotient of the angles of twist, a difference between the angles of twist, or a deviation of one angle of twist of the angles of twist from the other angle of twist of the angles of twist. The first angle of twist may be the first system parameter or the first measured variable. The second angle of twist may be the second system parameter or the second measured variable. A sensor system present in the system for registering the angles of twist in the first region and the second region can thus be used efficiently in order to monitor the torsional rigidity of the system without having to determine a moment.

According to a further embodiment of the method, in the step of determining the first system parameter, a first angle-of-twist curve ensuing in the first region on the basis of the torsional moment can be determined. The first angle-of-twist curve may comprise an angle-of-twist difference or an angle-of-twist shift over the first region. The angle-of-twist difference or the angle-of-twist shift can be derived from the first angle-of-twist curve. According to this embodiment, in the step of determining the second system parameter, a second angle-of-twist curve ensuing in the second region on the basis of the torsional moment can be determined. The second angle-of-twist curve may comprise an angle-of-twist difference or an angle-of-twist shift over the second region. The angle-of-twist difference or the angle-of-twist shift can be derived from the first angle-of-twist curve. Furthermore, in the comparison step, the first angle-of-twist curve can be compared with the second angle-of-twist curve. The first angle-of-twist curve may comprise at least two angles of twist ensuing in the first region. The second angle-of-twist curve may comprise at least two angles of twist ensuing in the second region. The comparison result resulting from the comparison step may thus, for example, be a ratio between a first angle-of-twist difference ensuing in the first region and a second angle-of-twist difference ensuing in the second region. Thus, in some embodiments, the ratio for monitoring the torsional rigidity may be carried out independently of the load acting on the system in order to determine a change to the torsional rigidity of the system.

According to a further embodiment of the method, in the presupposition step, the region that has the predetermined torsional rigidity may be a predetermined region of the system. The predetermined region of the system may be a region having a predetermined torsional rigidity that is constant over time. The predetermined region of the system may be a region having a known torsional rigidity. The step of determining the change to the torsional rigidity can thus, with the presupposition step, be based on the assumption that the torsional rigidity of the system does not change in the region having the predetermined torsional rigidity. By way of example, the predetermined region may be a region of the system that is made of a material, for example a metal, that has a predetermined torsional rigidity that is constant over time for the operation of the system. The material may have a known torsional rigidity. The system parameter ensuing in the predetermined region on the basis of the torsional moment, or the measured variable sensed at the predetermined region, can thus act as a reference parameter or a reference variable for the method and the step of determining the change to the torsional rigidity. The reference parameter or reference variable is, however, not a predetermined reference parameter or a predetermined reference variable; rather, the reference parameter or reference variable may be a reference parameter or reference variable that is determined when the method is carried out while the system is in operation. Taking the predetermined torsional rigidity as given, the method for monitoring the torsional rigidity can therefore advantageously be carried out in a self-referencing manner.

According to a further embodiment of the method, the presupposition step can be carried out after the comparison step. According to this embodiment, in the presupposition step, the region having the predetermined torsional rigidity can be established on the basis of the comparison result resulting from the comparison step. Thus, the region having the predetermined torsional rigidity may also be a non-predetermined region of the system that can be established only once the system is in operation. The embodiment can be based on the assumption that at least one region out of the first region and the second region has a torsional rigidity that is constant over time and does not change in the established region. The first region may be a system segment or system component. The second region may be a further system segment or the same system component. The method can be based on the assumption that when the torsional rigidity of the system is unchanged, the system parameters, measured variables, angles of twist, or angle-of-twist curves do not deviate from one another. If, however, the comparison result reveals any such deviation, it can be determined, on the basis of the deviation, whether and in which region of the system the torsional rigidity has changed.

According to a further embodiment of the method, the step of determining the change to the torsional rigidity is carried out depending on at least one influencing variable that acts on the system and influences at least one system parameter out of the first system parameter and the second system parameter. In principle, the influencing variable may be any external or internal influencing variable acting on the system from the exterior or the interior. The influencing variable may be an environmental influencing variable, for example a temperature at which the system is operated or which the system is at. In consideration of the influencing variables acting on the system, the method for monitoring the torsional rigidity can be carried out robustly in order to determine the change to the torsional rigidity even independently of a changing influencing variable acting on the system.

According to a further embodiment of the method, the method may, as a further step, comprise determining a location along an axis of rotation of the system at which the torsional rigidity of the system has changed. The step of determining the location can be carried out on the basis of the comparison result resulting from the comparison step. In the step of determining the location, it can be determined that the location along the axis of rotation is in the first region or the second region. In the determination step, it can be determined that the location is in that other region out of the first region and the second region which has not been presupposed as having the predetermined torsional rigidity in the presupposition step. In this way, it is possible to reliably determine in the system a potential defect site at which the system is at risk of failure owing to a changing torsional rigidity.

According to a further embodiment of the method, the system may have a machine shaft for transmitting a torque. The machine shaft may, for example, be a sun shaft of a machine transmission. According to this embodiment, the other region which has not been presupposed as having the predetermined torsional rigidity in the presupposition step is a region or a component part of the machine shaft. The region which has been presupposed as having the predetermined torsional rigidity in the presupposition step may also be a component part of the machine shaft. Thus, the method can be used to determine the region in which or the location along the machine shaft at which the torsional rigidity has changed. Therefore, the method can be used to monitor the machine shaft for any failure or rupture that may result from a decreased torsional rigidity.

According to a further embodiment of the method, the other region which has not been presupposed as having the predetermined torsional rigidity in the presupposition step may be made at least in part of a composite material. Thus, the method can be used to monitor a decreased torsional rigidity in a system region or machine shaft region made of the composite material. Therefore, by using the method, the operation of a rotationally driven system made at least in part of a composite material can be maintained in an operationally safe way.

In a further aspect, the present disclosure relates to a monitoring device for monitoring a torsional rigidity of a rotationally driven system configured to carry out the method according to the preceding aspect. The monitoring device may have at least one arithmetic logic unit for carrying out the steps of the method. Furthermore, the monitoring device may have an alarm unit that generates an alarm signal and can output it via an interface. The alarm unit can generate and output the alarm signal when the monitoring device determines that the torsional rigidity has changed when carrying out the step of determining such change. The alarm signal generated and output can also contain spatial information relating to that other region out of the first region and the second region in which the torsional rigidity of the system has changed. On the basis of an alert of this kind, a system operator can perform pre-emptive maintenance or repairs in the determined other region in order to prevent the system being damaged.

In yet another aspect, the present disclosure relates to an installation having a rotationally driven system and the monitoring device according to the preceding aspect for monitoring a torsional rigidity of the system. The installation may be a machine installation, for example a wind turbine. Embodiments and features of one aspect may form corresponding embodiments and features of any other aspect.

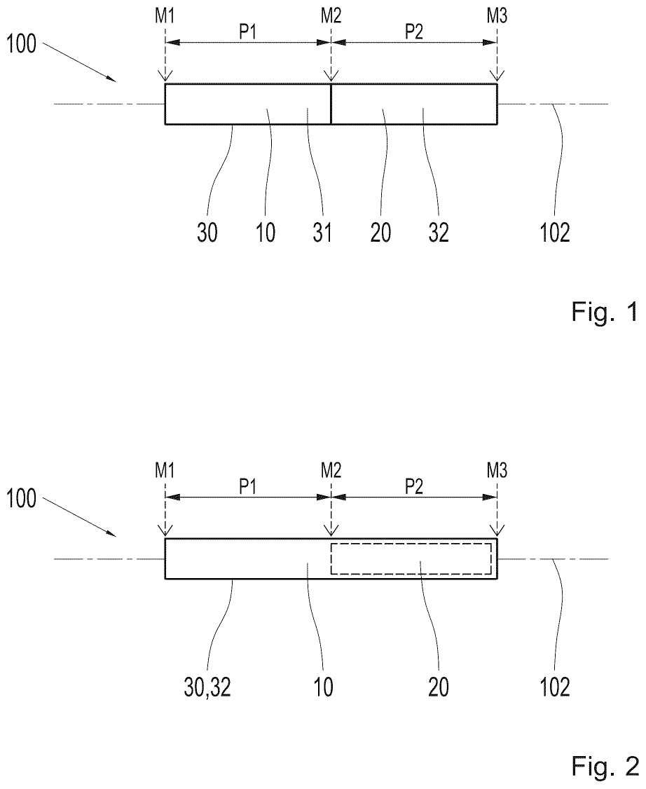

FIG. 1 shows a system 100, which, according to the schematically shown embodiment, is a machine shaft 30. The machine shaft 30 is rotationally driven, with the machine shaft 30 rotating about an axis of rotation 102. A torque transmitted to the machine shaft 30 generates a torsion of the machine shaft 30. The machine shaft 30 has a torsional rigidity that impacts on an angle-of-twist curve of the machine shaft 30 along the axis of rotation 102.

In the embodiment of the system 100 shown in FIG. 1, the machine shaft 30 has a first predetermined region 10 and a second predetermined region 20 which adjoin one another. The first region 10 is made of a reference material 31—of a metal material, for example steel, according to one embodiment. The second region 20 is made of a composite material 32, for example carbon fiber-reinforced plastics material.

In relation to the first region 10, a first torsional-rigidity-dependent system parameter P1 dependent on the torsional rigidity of the machine shaft 30 in the first region 10 is determined. According to one embodiment, a first measured value M1 and a second measured value M2 are registered on the machine shaft 30 in the first region 10, these being two angles of twist of the first region 10. The measurement sites at which the measured values M1, M2 are registered and to which the angles of twist relate are spaced apart from one another along the first region 10. According to the embodiment shown in FIG. 1, the measurement sites are located at the two axial boundaries of the first region 10. An angle-of-twist difference between the two angles of twist is derived as the first torsional-rigidity-dependent system parameter P1, the angle-of-twist difference being dependent on the torque acting on the system 100 and thus on the torsion acting in the first region 10 of the system 100.

In relation to the second region 20, a second torsional-rigidity-dependent system parameter P2 dependent on the torsional rigidity of the machine shaft 30 in the second region 20 is determined. According to one embodiment, the second measured value M2 and a third measured value M3 are registered on the machine shaft 30 in the second region 20, these being two angles of twist of the second region 20. The measurement sites at which the measured values M2, M3 are registered and to which the angles of twist relate are spaced apart from one another along the second region 20. According to the embodiment shown in FIG. 1, the measurement sites are located at the two axial boundaries of the second region 20. An angle-of-twist difference between the two angles of twist is derived as the second torsional-rigidity-dependent system parameter P2, the angle-of-twist difference being dependent on the torque acting on the system 100 and thus on the torsion acting in the second region 20 of the system 100.

FIG. 2 shows a further system 100, which, according to the schematically shown embodiment, is a machine shaft 30. The machine shaft 30 is rotationally driven, with the machine shaft 30 rotating about an axis of rotation 102. A torque transmitted to the machine shaft 30 generates a torsion of the machine shaft 30. The machine shaft 30 has a torsional rigidity that impacts on an angle-of-twist curve of the machine shaft 30 along the axis of rotation 102.

In the embodiment of the system 100 shown in FIG. 2, the machine shaft 30 has a first predetermined region 10 and a second predetermined region 20 which adjoin one another. The embodiment shown in FIG. 2 differs from the embodiment shown in FIG. 1 in that the first region 10 and the second region 20 are made of a composite material 32, for example carbon fiber-reinforced plastics material. Like in the embodiment shown in FIG. 1, the first torsional-rigidity-dependent system parameter P1 is determined in relation to the first region 10. Like in the embodiment shown in FIG. 1, the second torsional-rigidity-dependent system parameter P2 is determined in relation to the second region 20.

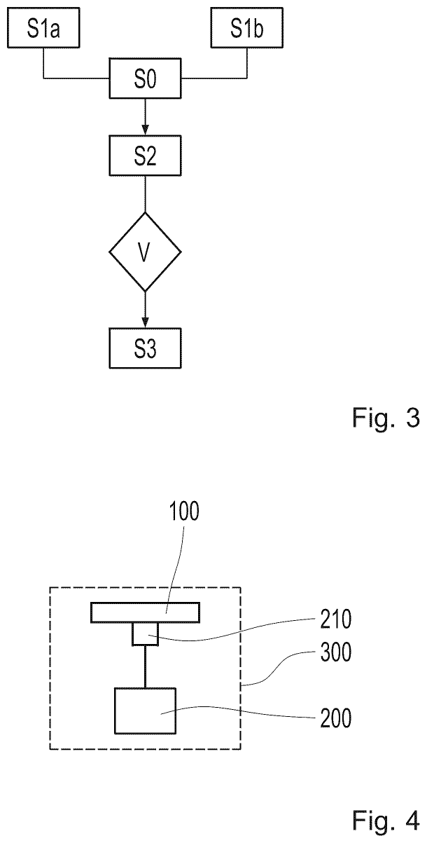

FIG. 3 shows steps of a method for monitoring the torsional rigidity of the rotationally driven system 100 shown in FIGS. 1 and 2. The method is carried out independently of a registration of the torque acting on the system 100 and independently of the torsion acting in the system 100. The presupposition, made in step S0, that one region out of the first region 10 and the second region 20 has a predetermined torsional rigidity forms the basis for the method as an assumption. The region that has the predetermined torsional rigidity may be a predetermined region according to the embodiment shown in FIG. 1, the predetermined region being the first region 10, which is made of the reference material 31. According to this embodiment, the region to be monitored is the second region 20, which is made of the composite material 32. The region having the predetermined torsional rigidity may be a region that is to be determined out of the first region 10 and the second region 20 according to the embodiment shown in FIG. 2, both regions 10, 20 being made of the composite material 32. According to this embodiment, the presupposition made in step S0 is based on the assumption that in any case one region out of the first region 10 and the second region 20 has a predetermined torsional rigidity which, according to one embodiment, is constant over time.

In a step S1a, the first torsional-rigidity-dependent system parameter P1 ensuing in the first region 10 on the basis of the torsional moment is determined. In a further step S1b, the second torsional-rigidity-dependent system parameter P2 ensuing in the second region 20 of the system 100 on the basis of the torsional moment is determined. In a further step S2, the first system parameter P1 is compared with the second system parameter P2. The comparison result V is a ratio between the angle-of-twist difference of the first region 10 and the angle-of-twist difference of the second region 20, the ratio being, or being assumed to be, independent of the torque acting on the system 100 or the load acting on the system 100.

In a further step S3, it is determined that the torsional rigidity of the system 100 has changed in that other region out of the first region 10 and the second region 20 which has not been presupposed as having the predetermined torsional rigidity in the presupposition step S0.

If the ratio between the angle-of-twist difference of the first region 10 and the angle-of-twist difference of the second region 20 for the embodiment of the system 100 shown in FIG. 1 deviates from a predetermined ratio, or the ratio changes as the method is carried out repeatedly over time, then in step S3 it can be established that the torsional rigidity has decreased in the second region 20, which is made of the composite material 32. The decreased torsional rigidity of the composite material 32 in the second region 20 is established on the basis of the presupposition or assumption that the torsional rigidity in the first region 10, which is made of the reference material 31, is unchanged and thus constant over time. In step S3, therefore, it can be determined for the embodiment shown in FIG. 1 that the second region 20 is defective or at risk of failure on the basis of a decreased torsional rigidity.

If the ratio between the angle-of-twist difference of the first region 10 and the angle-of-twist difference of the second region 20 for the embodiment of the system 100 shown in FIG. 2 deviates from a predetermined ratio, or the ratio changes as the method is carried out repeatedly over time, then in step S3 it can be established that the torsional rigidity has decreased in a region that is to be determined out of the first region 10 or the second region 20, which are both made of the composite material 32. The decreased torsional rigidity of the composite material 32 in one region out of the two regions 10, 20 is established on the basis of the presupposition or assumption that in any case the torsional rigidity in one region out of the two regions 10, 20, which are both made of the composite material 32, is unchanged and thus constant over time. On the basis of this assumption, in the event that the ratio or quotient between the first system parameter P1 and the second system parameter P2 increases or decreases as the method is carried out repeatedly over time, it can be established that the second region 20 or the first region 10 is defective or at risk of failure on the basis of a decreased torsional rigidity of the particular region 10, 20.

FIG. 4 schematically shows an installation 300 which has the rotationally driven system 100 and a monitoring device 200 configured to monitor the torsional rigidity of the system 100 and, for this purpose, to carry out the steps of the method described in FIG. 3. The monitoring device 200 has a sensor system 210 for registering the measured values M1, M2, M3 and thus for determining the system parameters P1, P2.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

10 First region
20 Second region
30 Machine shaft
31 Reference material
32 Composite material
100 System
102 Axis of rotation
200 Monitoring device
210 Sensor system
300 Installation
P1 First system parameter
P2 Second system parameter
S0 Presupposition of torsional rigidity
S1a Determination of first system parameter
S1b Determination of second system parameter
S2 Comparison of system parameters
S3 Determination of change to torsional rigidity
V Comparison result
M1 First measured value
M2 Second measured value
M3 Third measured value

1. A method for monitoring a torsional rigidity of a rotationally driven system, comprising:
determining a first torsional-rigidity-dependent system parameter ensuing in a first region of the system based on a torsional moment acting on the system;
determining a second torsional-rigidity-dependent system parameter ensuing in a second region of the system based on the torsional moment;
presupposing that one region out of the first region and the second region has a predetermined torsional rigidity;
comparing the first torsional-rigidity-dependent system parameter with the second torsional-rigidity-dependent system parameter; and
determining a change to the torsional rigidity of the system in that other region out of the first region and the second region which has not been presupposed as having the predetermined torsional rigidity, based on a comparison result resulting from the comparing.

2. The method according to claim 1, wherein, determining the first torsional-rigidity-dependent system parameter comprises sensing a first torsional-rigidity-dependent measured variable at the first region, wherein, determining the second torsional-rigidity-dependent system parameter comprises sensing a second torsional-rigidity-dependent measured variable at the second region, and wherein, comparing the first torsional-rigidity-dependent system parameter with the second torsional-rigidity-dependent system parameter comprises comparing the first torsional-rigidity-dependent measured variable with the second torsional-rigidity-dependent measured variable.

3. The method according to claim 1, wherein the first torsional-rigidity-dependent system parameter and the second torsional-rigidity-dependent system parameter are system parameters of a same kind.

4. The method according to claim 1, wherein determining the first torsional-rigidity-dependent system parameter comprises determining a first angle of twist ensuing in the first region based on the torsional moment, wherein, determining the second torsional-rigidity-dependent system parameter comprises determining a second angle of twist ensuing in the second region based on the torsional moment, and wherein the comparing comprises comparing the first angle of twist with the second angle of twist.

5. The method according to claim 1, wherein, in the step of determining the first torsional-rigidity-dependent system parameter, a first angle-of-twist curve ensuing in the first region based on the torsional moment is determined, wherein, in the step of determining the second torsional-rigidity-dependent system parameter, a second angle-of-twist curve ensuing in the second region based on the torsional moment is determined, and wherein the comparing comprises comparing the first angle-of-twist curve with the second angle-of-twist curve.

6. The method according to claim 1, wherein the region that has the predetermined torsional rigidity is a predetermined region of the system.

7. The method according to claim 1, wherein presupposition is carried out after the comparing, and wherein the region having the predetermined torsional rigidity is established based on the comparison result resulting from the comparing.

8. The method according to claim 1, wherein determining the change to the torsional rigidity is carried out based on at least one influencing variable that acts on the system and influences at least one system parameter out of the first torsional-rigidity-dependent system parameter and the second torsional-rigidity-dependent system parameter.

9. The method according to claim 1, further comprising determining a location along an axis of rotation of the system at which the torsional rigidity of the system has changed, based on the comparison result resulting from the comparing.

10. The method according to claim 1, wherein the system has a machine shaft for transmitting a torque, and wherein the other region which has not been presupposed as having the predetermined torsional rigidity is a component part of the machine shaft.

11. The method according to claim 1, wherein the other region which has not been presupposed as having the predetermined torsional rigidity is made at least in part of a composite material.

12. A monitoring device for monitoring a torsional rigidity of a rotationally driven system, configured to carry out the method according to claim 1.

13. An installation having a rotationally driven system and the monitoring device according to claim 12 for monitoring a torsional rigidity of the system.
